(19) United States
(12) Patent Application Publication
(10) Pub. No.: US 2012/0327638 A1
(43) Pub. Date: Dec. 27, 2012

(54) ILLUMINATION APPLIANCE

(75) Inventors: Yusuke Tajima, Osaka (JP); Yuji Nakagawa, Osaka (JP); Hideomi Furuya, Nara (JP)

(73) Assignee: PANASONIC CORPORATION, Osaka (JP)

(21) Appl. No.: 13/582,599

(22) PCT Filed: Feb. 28, 2011
(86) PCT No.: PCT/JP2011/054545

§ 371 Date: Sep. 4, 2012

(30) Foreign Application Priority Data
Mar. 5, 2010 (JP) 2010-049752

(51) Int. Cl. F21S 8/02; F21V 29/00

(52) U.S. Cl. 362/147

(57) ABSTRACT

An Illumination appliance includes: an appliance body which houses a light source; a frame which is attached to the appliance body; and a power supply unit. The power supply unit is attached to a portion of a top surface of the appliance body and which is configured to feed power to the light source.

### TECHNICAL FIELD

The present invention relates to an illumination appliance that is applied to, for example, a downlight embedded in a ceiling construction surface with an LED as a light source.

### BACKGROUND ART

There has been known an illumination appliance including a power supply unit attached to an outer bottom surface of an appliance body such that the power supply unit is located in an outside area of the appliance body through an arm portion (for example, refer to Patent Document 1).

### RELATED ART DOCUMENTS

### Patent Documents

Patent Document 1: JP-A-2008-159455 (FIG. 1, paragraph 0023)

### SUMMARY OF THE INVENTION

### Problem to be Solved by the Invention

There is a need for a reduction of size of a downlight illumination appliance embedded in the ceiling construction surface so as not to require a larger attaching hole to be formed in the ceiling construction surface. Also, the illumination appliance of this type has been required to have high heat-radiation characteristics because the illumination appliance is used in an enclosed space within the ceiling construction surface.

In the illumination appliance of Patent Document 1, since the arm portion is coupled to a radiation fin, heat can be excellently radiated from the power supply unit. However, since the power supply unit largely protrudes outward from the appliance body, the overall contour of the power supply unit becomes large.

On the other hand, there has been proposed an illumination appliance that is attached to an upper surface of the appliance body having the radiation fin so that the power supply unit is attached into the appliance body.

However, in the above conventional illumination appliance, because the illumination appliance is attached to the upper surface of the appliance body so that the power supply unit is attached into the appliance body, the degree of freedom in the arrangement of the radiation fin in the appliance body is lowered, thereby making it difficult to obtain higher radiation characteristics.

The present invention has been made to solve the above-mentioned problem, and an object thereof is to provide an illumination appliance which can be reduced in size and which can obtain high heat-radiation characteristics.

### Means for Solving the Problem

An Illumination appliance of the present invention includes: an appliance body which houses a light source; a frame which is attached to the appliance body; and a power supply unit which is attached to a portion of a top surface of the appliance body and which is configured to feed power to the light source.

In the Illumination appliance of the present invention, the appliance body includes a radiation film on a remaining portion of the top surface.

In the Illumination appliance of the present invention, the radiation fin is obliquely cut away.

In the Illumination appliance of the present invention, a spacer is interposed between the appliance body and the power supply unit.

In the Illumination appliance of the present invention, the power supply unit includes a radiation fin on a bottom surface thereof.

In the Illumination appliance of the present invention, the power supply unit includes a radiation fin on radial surfaces thereof.

### Advantages of the Invention

The illumination appliance of the present invention can provide advantages of reduction of size and high heat-radiation characteristics.

### BRIEF DESCRIPTION OF THE DRAWINGS

FIG. 1 is an external perspective view of an illumination appliance as viewed obliquely from above according to the first embodiment.

FIG. 2 is an external perspective view of an appliance body in the illumination appliance in FIG. 1.

FIG. 3 is a side view of an illumination appliance according to a second embodiment of the present invention.

FIG. 4 is an external perspective view of an appliance body in the illumination appliance of FIG. 3.

FIG. 5 is an external perspective view of an illumination appliance as viewed obliquely from above according to a third embodiment of the present invention.

FIG. 6 is an external perspective view of a power supply unit in the illumination appliance of FIG. 5 as viewed obliquely from below.

### MODE FOR CARRYING OUT THE INVENTION

Hereinafter, a description will be given of an illumination appliance according plural embodiments of the present invention with reference to the drawings.

### First Embodiment

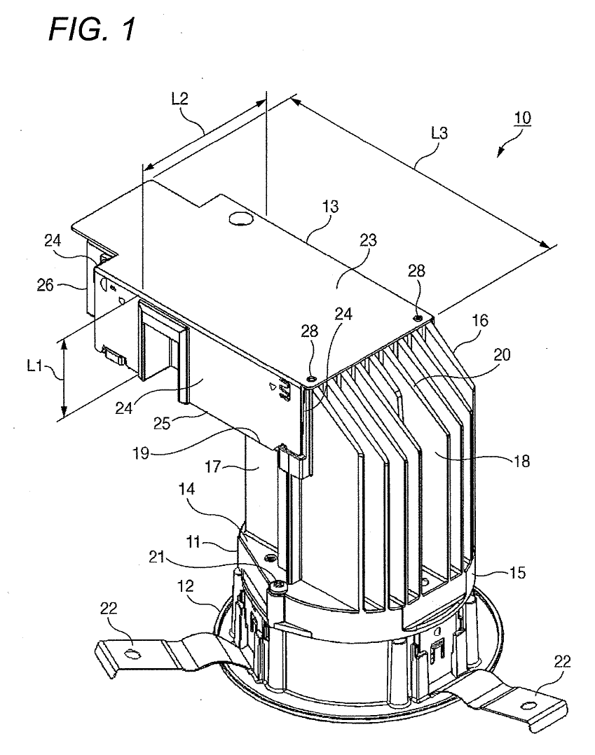

As illustrated in FIG. 1, an illumination appliance 10 according to a first embodiment of the present invention is a downlight that includes an appliance body 11, an LED light emitting unit (not shown) which is a light source housed in the appliance body 11, a frame 12, and a power supply unit 13, and is embedded in a attaching hole (not shown) defined in a ceiling construction surface (not shown).

The appliance body 11 is made of a hard resin material having an insulation property, and formed into a cylindrical shape having a top plate 14 and a peripheral plate 15. In the appliance body 11, plural radiation fins 16 protrude upward from an upper surface of the top plate 14. The radiation fins 16 include: a first radiation fin portion 17 provided on an area corresponding to a substantially half area of the top plate 14, and protruding toward an upper end thereof in an axial direction of the appliance body 11; and a second radiation fin portion 18 provided on an area corresponding to the remaining half area of the top plate 14, and protruding up to the upper end in the axial direction of the appliance body 11. An upper end surface of the first radiation fin portion 17 is formed with a power supply unit attaching portion 19 having a plane orthogonal to the axial direction of the appliance body 11. The second radiation fin portion 18 has a cut portion 20 obliquely cut away at a position close to the upper end.

The LED light emitting unit is attached to a lower surface of the top plate 14 of the appliance body 11 so as to be surrounded by the peripheral plate 15, and has plural LED chips (not shown) mounted on a circuit board (not shown). The LED chips are arranged so that a main optical axis thereof trends downward. The frame 12 is made of a material equivalent to that of the appliance body 11, and formed into a cylindrical shape having the same outer diameter dimension as the outer diameter dimension of the appliance body 11. The frame 12 is assembled integrally with the appliance body 11 by allowing screws 21 to be screwed into the frame 12 from the top plate 14 of the appliance body 11. A reflector may be disposed on an inner periphery of the frame 12. Plural metal attaching springs 22 are fitted on an outer periphery of the frame 12. The attaching springs 22 are elastically deformed in an axial direction of the appliance body 11 when the appliance body 11 is inserted into the attaching hole of the ceiling construction surface. Then, the attaching springs 22 are elastically restored in a horizontal direction after the appliance body 11 has been inserted into the attaching hole, and then locked with the upper surface of the ceiling construction surface. As a result, the attaching springs 22 support the appliance body 11 to the ceiling construction surface.

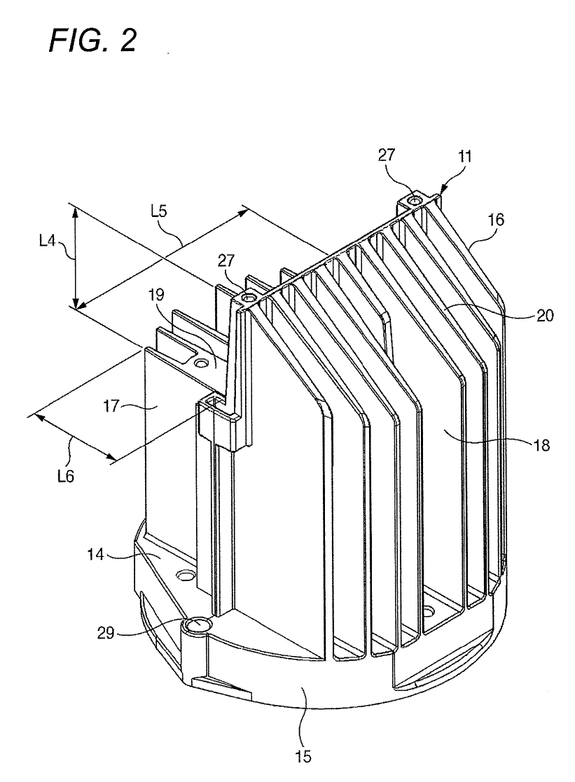

The power supply unit 13 is formed into a cuboid having a top plate 23, two pairs of side plates 24, and a bottom plate 25, and includes an electric component for converting a commercial power supply into a DC power supply for the LED light emitting unit therein. The power supply unit 13 is electrically connected to an external commercial power supply through a supply terminal block 26 attached to a terminal, and also electrically connected to a printed circuit provided on a circuit board of the LED light emitting unit. The power supply unit 13 has a height dimension L1, a width dimension L2, and a length dimension L3. The power supply unit 13 is assembled by allowing screws 28 to be screwed from an end of the top plate 23 into screw holes (refer to FIG. 2) defined in an upper end of the second radiation fin portion 18 of the appliance body 11 so that the bottom plate 25 abuts against the power supply unit attaching portion 19.

As illustrated in FIG. 2, the appliance body 11 has screw holes 27 in an upper end of the second radiation fin portion 18, and screw holes 29 for screwing the screws 21 into the top plate 14. In the appliance body 11, the power supply unit attaching portion 19 has a height dimension L4 substantially equal to the height dimension L1 of the power supply unit 13, a width dimension L5 substantially equal to the width dimension L2 of the power supply unit 13, and a length dimension L6 sufficiently shorter than the length dimension L3 of the power supply unit 13.

In the illumination appliance 10 of this type, the screws 21 are screwed into the frame 12 through the screw holes 29 of the appliance body 11 so that the frame 12 is assembled integrally with the appliance body 11. Thereafter, the screws 28 are screwed into the screw holes 27 in the upper end of the second radiation fin portion 18 of the appliance body 11 from the end of the top plate 23 of the power supply unit 13 so that the power supply unit 13 is attached to the power supply unit attaching portion 19 of the appliance body 11. In this situation, in the appliance body 11, the power supply unit 13 is attached to the power supply unit attaching portion 19 located on a side of the second radiation fin portion 18, which corresponds to a substantially half area of the top plate 14 in the radiation fins 16, and has the width dimension L5 substantially equal to the width dimension L2 of the power supply unit 13. For that reason, the appliance body 11 thermally connects the second radiation fin portion 18 to the side plates 24 of the power supply unit 13, and also thermally connects the first radiation fin portion 17 to the bottom plate 25 of the power supply unit 13.

Accordingly, in the illumination appliance 10 according to the first embodiment, the power supply unit 13 is attached to the power supply unit attaching portion 19 corresponding to the substantially half area which is a part of the top plate 14.

As a result, in the illumination appliance 10 according to the first embodiment, as compared with the conventional art in which the power supply unit is attached to the external bottom surface of the appliance body through the arm portion so as to be located in the outside area of the appliance body, the power supply unit 13 is not largely extruded to the external of the appliance body 11, and therefore the size of the entire illumination appliance can be reduced.

Also, in the illumination appliance 10 according to the first embodiment, the power supply unit 13 is attached to the power supply unit attaching portion 19 corresponding to the substantially half area, which is a part of the top plate 14.

As a result, in the illumination appliance 10 according to the first embodiment, as compared with the conventional art in which the power supply unit is attached to the upper surface of the appliance body, the degree of freedom in the arrangement of the radiation fin 16 in the appliance body 11 is increased, thereby making it possible to set the higher heat-radiation characteristics.

In the illumination appliance 10 according to the first embodiment, the first radiation fin portion 17 and the second radiation fin portion 18 are arranged around the power supply unit attaching portion 19.

As a result, in the illumination appliance 10 according to the first embodiment, the radiation fins 16 are thermally connected to the entire periphery of the power supply unit 13 so that the high-efficient heat-radiation characteristics can be obtained.

Further, in the illumination appliance 10 according to the first embodiment, the cut portion 20 obliquely cut away is disposed at a position close to the upper end of the second radiation fin portion 18.

As a result, in the illumination appliance 10 according to the first embodiment, the heat-radiation characteristics can be improved because the radiation area of the second radiation fin portion 18 is enlarged. Also, the construction property can be improved because the upper end surface of the appliance body 11 does not interfere with a ceiling material when the ceiling construction surface is constructed.

In addition, in the illumination appliance 10 according to the first embodiment, the power supply unit attaching portion 19 that is thermally connected to the first radiation fin portion 17 and the second radiation fin portion 18 has the height dimension L4 substantially equal to the height dimension L1 of the power supply unit 13.

As a result, in the illumination appliance 10 according to the first embodiment, the radiation fins 16 high in the degree of freedom can be arranged without protruding the radiation fins 16 upward from the upper end of the power supply unit 13.

Further, in the illumination appliance 10 according to the first embodiment, the power supply unit attaching portion 19 that is thermally connected to the first radiation fin portion 17 and the second radiation fin portion 18 has the width dimension L5 substantially equal to the width dimension L2 of the power supply unit 13.

As a result, in the illumination appliance 10 according to the first embodiment, the radiation fins 16 high in the degree of freedom can be arranged without protruding the radiation fins 16 in the width direction of the power supply unit 13.

### Second Embodiment

Subsequently, a description will be given of an illumination appliance according to a second embodiment of the present invention. In the following respective embodiments, the constituent elements overlapped with and the functionally same constituent elements as those in the above-mentioned first embodiment are denoted by identical symbols or equivalent symbols in the drawings, and therefore a description thereof will be simplified or omitted.

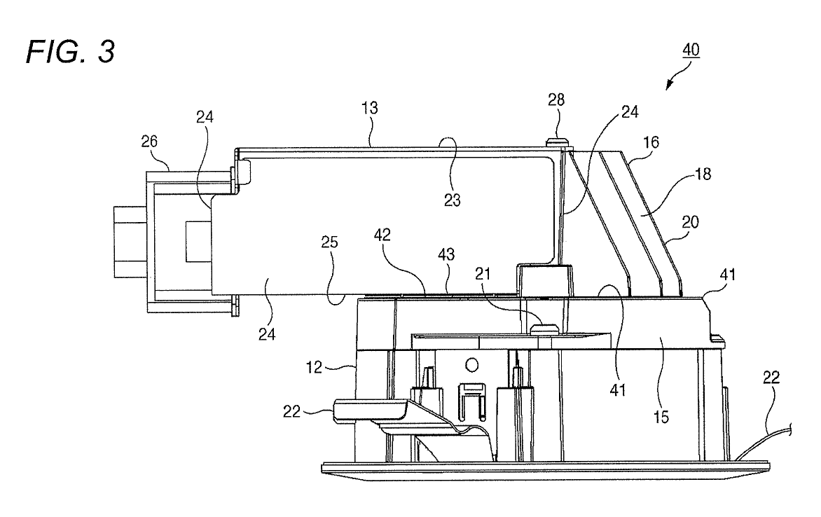

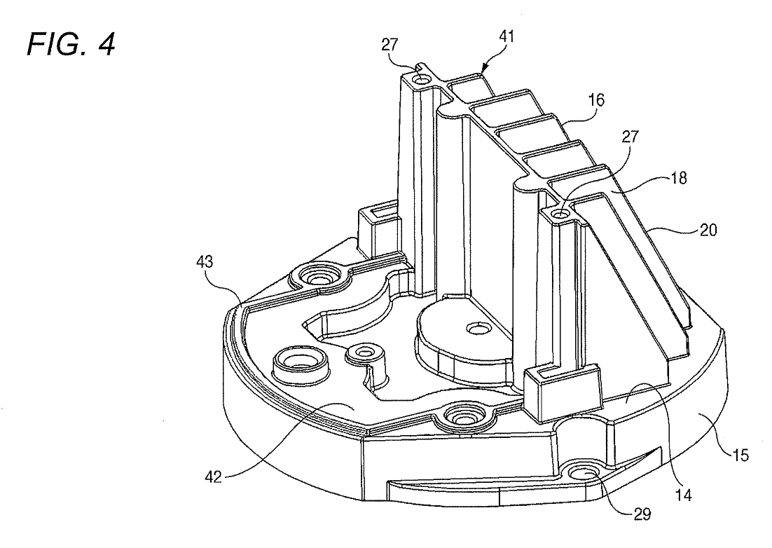

As illustrated in FIGS. 3 and 4, an illumination appliance 40 according to a second embodiment of the present invention employs an appliance body 41 having a power supply unit attaching portion 42 disposed in an area corresponding to a substantially half of the top plate 14 in the upper surface of the top plate 14. A spacer 43 is formed on the power supply unit attaching portion 42. The spacer 43 is formed on the power supply unit attaching portion 42 of the top plate 14 into an endless rib shape having a predetermined height dimension. For that reason, when the power supply unit 13 is attached to the power supply unit attaching portion 42, a space is defined between the bottom plate 25 of the power supply unit 13 and the top plate 14 of the appliance body 41. As the spacer 43, the rib shape shown in the figure may be replaced with a gap member of an O-ring or a washer.

Accordingly, in the illumination appliance 40 according to the second embodiment, the space is defined between the bottom plate 25 of the power supply unit 13 and the top plate 14 of the appliance body 41.

As a result, in the illumination appliance 40 according to the second embodiment, heat from the LED light emitting unit is not directly propagated to the power supply unit 13, and heat from the power supply unit 13 is not directly propagated to the appliance body 41. For that reason, an influence of the heat on the power supply unit 13 and the appliance body 41 can be reduced.

### Third Embodiment

Subsequently, a description will be given of an illumination appliance according to a third embodiment of the present invention.

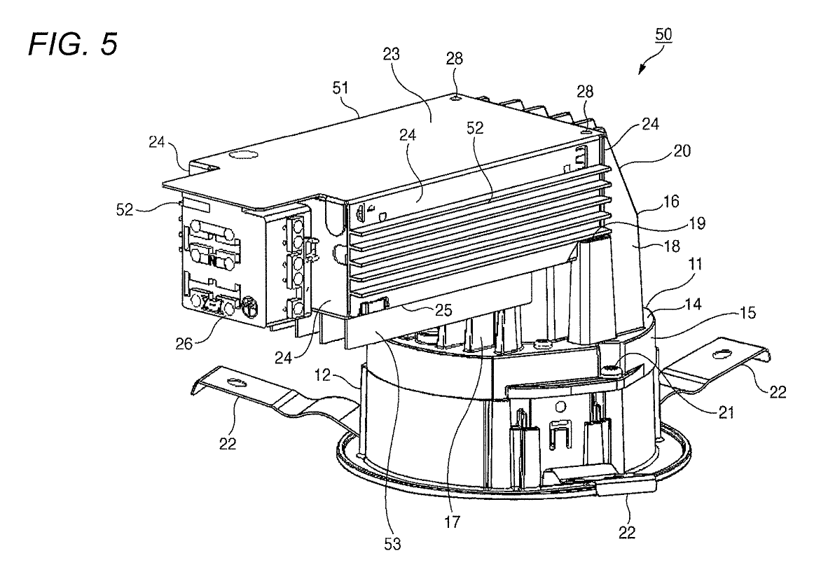

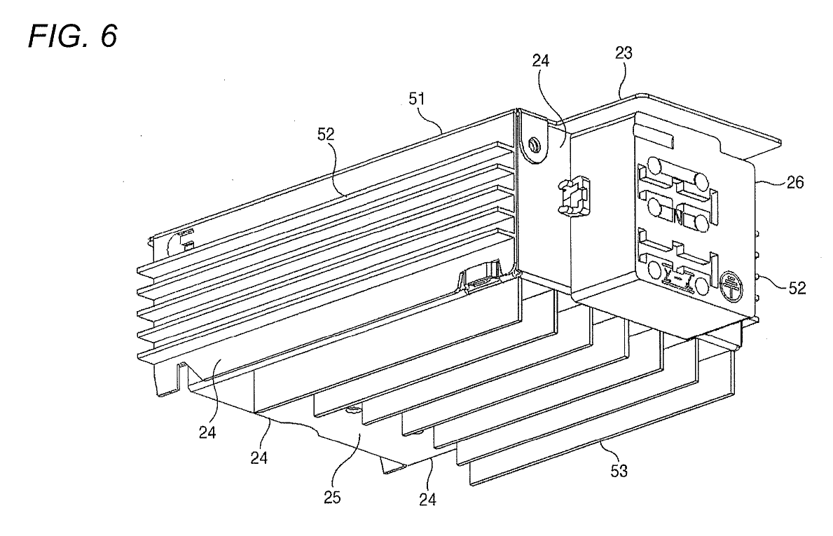

As illustrated in FIGS. 5 and 6, an illumination appliance 50 according to the third embodiment of the present invention employs a power supply unit 51 having a radiation fin 52 on each of the pair of side plates 24 on the long sides, and having a radiation fin 53 on the bottom plate 25.

Accordingly, in the illumination appliance 50 according to the third embodiment, the heat of the power supply unit 51 is radiated through the radiation fins 52 on the pair of side plates 24.

As a result, in the illumination appliance 50 according to the third embodiment, the heat of the power supply unit 51 is efficiently radiated from the lateral sides thereof so that the heat-radiation characteristics of the power supply unit 51 can be improved.

Also, in the illumination appliance 50 according to the third embodiment, the heat of the power supply unit 51 is radiated through the radiation fin 53 of the bottom plate 25.

As a result, in the illumination appliance 50 according to the third embodiment, the heat of the power supply unit 51 is efficiently radiated from the bottom thereof so that the heat-radiation characteristics of the power supply unit 51 can be improved.

The appliance body, the frame, and so on used in the embodiments are not limited to those exemplified, but can be appropriately changed.

The present invention is based on Japanese Patent Application No. 2010-049752 filed on Mar. 5, 2010, contents of which are incorporated herein by reference.

### DESCRIPTION OF REFERENCE SIGNS

10, 40, 50: Illumination Appliance

11, 41: Appliance Body

12: Frame

13, 51: Power Supply Unit

16, 52, 53: Radiation Fin

17: First Radiation Fin Portion (Radiation Fin)

18: Second Radiation Fin Portion (Radiation Fin)

43: Spacer

1. An Illumination appliance comprising:
an appliance body which houses a light source;
a frame which is attached to the appliance body; and
a power supply unit which is attached to a portion of a top surface of the appliance body and which is configured to feed power to the light source.

2. The Illumination appliance according to claim 1,
wherein the appliance body comprises a radiation film on a remaining portion of the top surface.

3. The Illumination appliance according to claim 2,
wherein the radiation fin is obliquely cut away.

4. The Illumination appliance according to claim 1,
wherein a spacer is interposed between the appliance body and the power supply unit.

5. The Illumination appliance according to claim 1,
wherein the power supply unit comprises a radiation fin on a bottom surface thereof.

6. The Illumination appliance according to claim 1,
wherein the power supply unit comprises a radiation fin on radial surfaces thereof.
